(19) United States
(12) Patent Application Publication
(10) Pub. No.: US 2026/0328666 A1
(43) Pub. Date: Oct. 22, 2026

(54) TEST DEVICE AND TEST METHOD USING THE SAME

(71) Applicant: Samsung Display Co., Ltd., Yongin-si (KR)

(72) Inventors: JUNHEE BAE, Yongin-si (KR); MOO-HYUN JO, Yongin-si (KR); YUN HEO, Yongin-si (KR)

(21) Appl. No.: 19/534,074

(22) Filed: Feb. 9, 2026

(30) Foreign Application Priority Data
Apr. 22, 2025 (KR) 10-2025-0052625
Jun. 24, 2025 (KR) 10-2025-0083755

(51) Int. Cl. G01N 3/22

(52) U.S. Cl. CPC G01N 3/22; G01N 2203/0003; G01N 2203/0021; G01N 2203/0037; G01N 2203/0206; G01N 2203/0647

(57) ABSTRACT

A test device including: a first fixing portion configured to fix a printed circuit board connected to one of two sides of a flexible printed circuit board, the two sides of the flexible printed circuit board being opposite to each other in a first direction; a second fixing portion spaced apart from the first fixing portion in the first direction and configured to fix a display panel connected to the other of the two sides of the flexible printed circuit board; and a rotating bar extending in the first direction and connected to the first fixing portion and the second fixing portion. The rotating bar is configured to rotate about a rotation axis defined at a center of the rotating bar and extends in the first direction when viewed in the first direction.

### CROSS-REFERENCE TO RELATED APPLICATION(S)

The present application claims priority to and the benefit of Korean Patent Applications Nos. 10-2025-0052625 and 10-2025-0083755, filed on Apr. 22, 2025 and Jun. 24, 2025, respectively, in the Korean Intellectual Property Office, the entire disclosures of both of which are incorporated herein by reference

### BACKGROUND

### 1. Field

Aspects of embodiments of the present disclosure relate to a test device and a test method using the test device.

### 2. Description of the Related Art

Generally, a display device includes a display panel including pixels for generating images, a driver connected to the pixels, and a controller for controlling the operation of the driver.

The driver may be disposed on a flexible printed circuit board, and the controller may be disposed on a printed circuit board. In such a case, one side of the flexible printed circuit board is connected to the printed circuit board, and the other side of the flexible printed circuit board is connected to the display panel. The driver is connected to the display panel via the flexible printed circuit board, and the controller is connected to the flexible printed circuit board via the printed circuit board.

During the manufacturing of the display device, while the flexible printed circuit board is connected to the display panel and the printed circuit board, the flexible printed circuit board, the display panel, and the printed circuit board are transported for subsequent processes. During the transportation, the flexible printed circuit board, due to its flexibility, is prone to moving out of the plane of (e.g., moving out of plane with) the display panel and the printed circuit board, resulting in twisting and bending.

If the flexible printed circuit board is twisted, the flexible printed circuit board may be damaged. To verify the durability of the flexible printed circuit board, a test device is used to measure the damage to the flexible printed circuit board according to its twist angle.

### SUMMARY

Embodiments of the present disclosure provide a test device to measure a durability of a flexible printed circuit board and a test method using the test device.

Embodiments of the present disclosure provide a test device including a first fixing portion configured to fix a printed circuit board connected to one of two sides of a flexible printed circuit board, the two sides being opposite to each other in a first direction, a second fixing portion spaced apart from the first fixing portion in the first direction and configured to fix a display panel connected to the other of the two sides of the flexible printed circuit board, and a rotating bar extending in the first direction and connected to the first fixing portion and the second fixing portion. The rotating bar is configured to rotate about a rotation axis defined at a center of the rotating bar and extends in the first direction when viewed in the first direction.

Embodiments of the present disclosure provide a test device including a first fixing portion is configured to fix a first area of a display panel having the first area, a bending area, and a second area, which are continuously arranged in a first direction, a second fixing portion spaced apart from the first fixing portion in the first direction and is configured to fix a printed circuit board connected to the second area, a rotating bar extending in the first direction and connected to the first fixing portion and the second fixing portion, and a protractor on one side surface of the second fixing portion facing the first fixing portion in the first direction. The rotating bar is configured to rotate about a rotation axis defined at a center of the rotating bar and extends in the first direction when viewed in the first direction.

Embodiments of the present disclosure provide a test method including fixing, by a first fixing portion, a printed circuit board connected to one of two sides of a flexible printed circuit board, the two sides being opposite to each other in a first direction, fixing, by a second fixing portion spaced apart from the first fixing portion in the first direction, a display panel connected to the other of the two sides of the flexible printed circuit board, gradually rotating, by a rotating bar extending in the first direction and connected to the first fixing portion and the second fixing portion, the first fixing portion, and capturing an image of the flexible printed circuit board. The rotating bar rotates about a rotation axis defined at a center of the rotating bar and extends in the first direction when viewed in the first direction, the first fixing portion rotates about the rotation axis in a clockwise direction or a counter-clockwise direction by the rotating bar, and a position of the second fixing portion is fixed.

According to the above, the printed circuit board connected to the one side of the flexible printed circuit board is fixed by the first fixing portion, the display panel connected to the other side of the flexible printed circuit board is fixed by the second fixing portion, and the first fixing portion rotates according to the rotating bar.

According to the above, as the first fixing portion rotates, the flexible printed circuit board is gradually bent and twisted, and damage to the flexible printed circuit board is identified by using a camera. In addition, the twist angle at which the flexible printed circuit board is damaged is measured through the protractor. Therefore, the durability of the flexible printed circuit board is easily measured.

### BRIEF DESCRIPTION OF THE DRAWINGS

FIG. 1 is a perspective view of a test device according to an embodiment of the present disclosure;

FIG. 2 is a perspective view of a first-first fixing portion, a first-second fixing portion, a rotating bar, and a driver shown in FIG. 1;

FIG. 3 is a front view of a first fixing portion shown in FIG. 1 when viewed in a first direction;

FIG. 4 is a front view of a second fixing portion shown in FIG. 1 when viewed in a first direction;

FIG. 5 is a view of the first fixing portion shown in FIG. 1 in a rotated state;

FIG. 6 is a view of a protractor according to an embodiment of the present disclosure;

FIG. 7 is a plan view illustrating a test object tested by a test device according to an embodiment of the present disclosure;

FIG. 8 is a cross-sectional view taken along the line I-I’ in FIG. 7;

FIG. 9 is a view of a flexible printed circuit board shown in FIG. 8 in a bent state;

FIGS. 10 and 11 are views of a display panel, a flexible printed circuit board, and a printed circuit board shown in FIG. 9 placed on the test device shown in FIG. 1;

FIG. 12 is a cross-sectional view taken along the line II-II’ in FIG. 11;

FIG. 13 is an illustration of an operation of performing a twist test on a flexible printed circuit board by using a test device according to an embodiment of the present disclosure;

FIG. 14 is a perspective view of the flexible printed circuit board shown in FIG. 13 in a twisted state;

FIG. 15 is a view of a first fixing portion as shown in FIG. 14 in which a rotational operation is stopped due to damage to the flexible printed circuit board;

FIG. 16 is a cross-sectional view of a display device manufactured by using a flexible printed circuit board identical to the tested flexible printed circuit board;

FIG. 17 is a cross-sectional view of a display panel illustrated in FIG. 16;

FIG. 18 is a block diagram describing an electronic device including the display device illustrated in FIG. 16;

FIG. 19 is a schematic view illustrating electronic devices according to various embodiments;

FIG. 20 is a view of a test object according to an embodiment of the present disclosure;

FIG. 21 is a cross-sectional view taken along the line III-III’ in FIG. 20;

FIG. 22 is a view of a bending area illustrated in FIG. 21 in a bent state;

FIGS. 23 and 24 are views of a display panel and a printed circuit board shown in FIG. 21 placed on the test device illustrated in FIG. 1; and

FIGS. 25-27 are views illustrating test devices according to embodiments of the present disclosure.

### DETAILED DESCRIPTION

In the present disclosure, it will be understood that when an element (or area, layer, or portion) is referred to as being "on", "connected to" or "coupled to" another element or layer, it can be directly on, connected or coupled to the other element or layer or intervening elements or layers may be present.

Like numerals refer to like elements throughout. In the drawings, the thickness, ratio, and dimension of components may be exaggerated for effective description of the technical content. As used herein, the term “and/or” may include any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present disclosure. As an example, without departing from the scope of the present disclosure, a first component, a first part, a first region, a first layer, and a first portion are referred to as a second component, a second part, a second region, a second layer, and a second portion, respectively, and vice versa. As used herein, the singular forms, “a”, “an” and “the” are intended to include the plural forms as well, unless the context clearly indicates otherwise.

Spatially relative terms, such as “below”, “lower”, “above”, “upper” and the like, may be used herein for ease of description to describe one element or feature’s relationship to another elements or features as shown in the figures.

It will be further understood that the terms “include” and/or “including” and “comprise” and/or “comprising” as similar terms, when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to accompanying drawings.

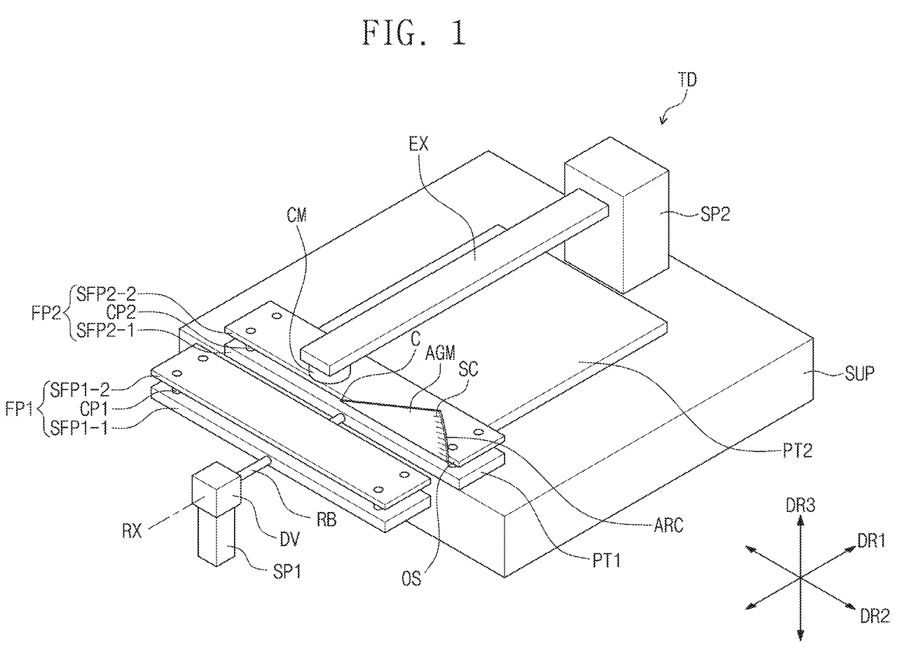

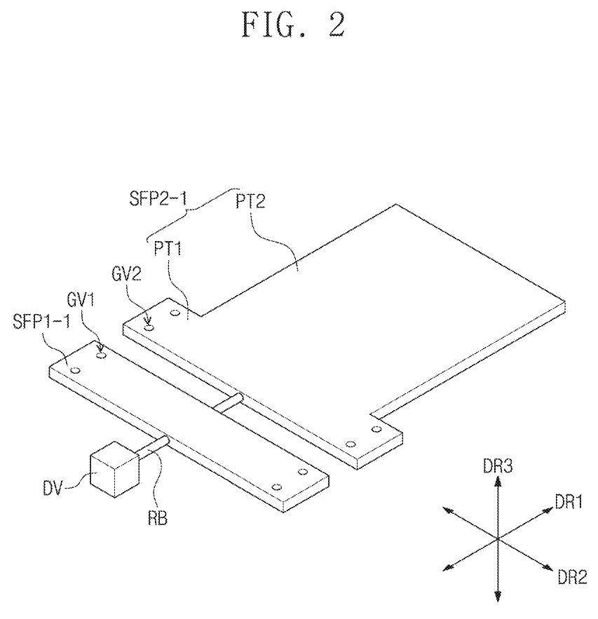

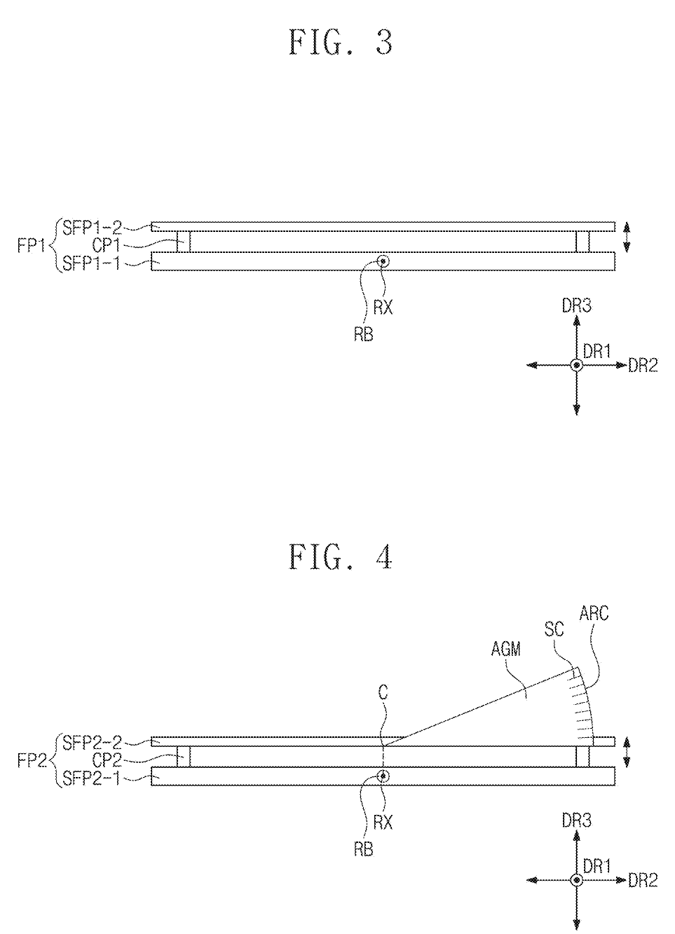

FIG. 1 is a perspective view of a test device according to an embodiment of the present disclosure. FIG. 2 is a perspective view of a first-first fixing portion, a first-second fixing portion, a rotating bar, and a driver shown in FIG. 1. FIG. 3 is a front view of a first fixing portion shown in FIG. 1 when viewed in a first direction. FIG. 4 is a front view of a second fixing portion shown in FIG. 1 when viewed in the first direction.

Referring to FIG. 1, the test device TD may include a first fixing portion FP1, a second fixing portion FP2, a rotating bar RB, a protractor AGM, a driver DV, a supporter SUP, a first support post SP1, a second support post SP2, an extension portion EX, and a camera CM.

Hereinafter, the first direction DR1 and a second direction DR2 crossing (e.g., intersecting) the first direction DR1 are defined in the drawings. In addition, a direction crossing (e.g., intersecting) a plane defined by the first and second directions DR1 and DR2 is referred to as a third direction DR3. In the following descriptions, the expression “when viewed in a plane” refers to a state of being viewed in the third direction DR3 unless the context indicates otherwise.

The first fixing portion FP1 may extend longer in the second direction DR2 than in the first direction DR1. The second fixing portion FP2 may be spaced apart from the first fixing portion FP1 in the first direction DR1. The first fixing portion FP1 and the second fixing portion FP2 may secure portions of a test object. The configurations of the first fixing portion FP1 and the second fixing portion FP2 to secure the test object will be described in more detail below.

Referring to FIGS. 1, 2, and 3, the first fixing portion FP1 may include a first-first fixing portion SFP1-1, a first-second fixing portion SFP1-2, and a plurality of first connection portions CP1.

Each of the first-first fixing portion SFP1-1 and the first-second fixing portion SFP1-2 may have a plane (e.g., may have a planar shape) defined by the first direction DR1 and the second direction DR2. Each of the first-first fixing portion SFP1-1 and the first-second fixing portion SFP1-2 may extend longer in the second direction DR2 than in the first direction DR1. Each of the first-first fixing portion SFP1-1 and the first-second fixing portion SFP1-2 may have a rectangular shape with short sides extending in the first direction DR1 and long sides extending in the second direction DR2.

The first-second fixing portion SFP1-2 may be disposed on the first-first fixing portion SFP1-1. The first-first fixing portion SFP1-1 and the first-second fixing portion SFP1-2 may be arranged to face each other in the third direction DR3 and may overlap each other. When viewed in the plane, the first-first fixing portion SFP1-1 and the first-second fixing portion SFP1-2 may have substantially the same area.

The first connection portions CP1 may be disposed between the first-first fixing portion SFP1-1 and the first-second fixing portion SFP1-2 to connect the first-first fixing portion SFP1-1 and the first-second fixing portion SFP1-2. The first-first fixing portion SFP1-1 and the first-second fixing portion SFP1-2 may be moved by the first connection portions CP1 to become closer to or farther from each other in a vertical direction, for example, the third direction DR3.

For example, the first connection portions CP1 may be fixedly connected to the first-second fixing portion SFP1-2 and may be connected to the first-first fixing portion SFP1-1 by being inserted into a plurality of first grooves GV1 defined in an upper surface of the first-first fixing portion SFP1-1. The first grooves GV1 may be adjacent to both sides of the first-first fixing portion SFP1-1, which are opposite to each other in the second direction DR2.

The first connection portions CP1 may reciprocate in the third direction DR3 with respect to the first-first fixing portion SFP1-1 along the first grooves GV1. Small motors may be arranged in the first-first fixing portion SFP1-1 to move the first connection portions CP1 in the third direction DR3. However, the present disclosure should not be limited thereto or thereby, and according to an embodiment, the first connection portions CP1 may be implemented as bolts.

A component to be secured of the test object may be disposed between the first-first fixing portion SFP1-1 and the first-second fixing portion SFP1-2. The first-first fixing portion SFP1-1 and the first-second fixing portion SFP1-2 may move closer to each other by the first connection portions CP1, and thus, the first-first fixing portion SFP1-1 and the first-second fixing portion SFP1-2 may fix the component to be secured of the test object. This configuration will be described in detail below.

Referring to FIGS. 1, 2, and 4, the second fixing portion FP2 may include a second-first fixing portion SFP2-1, a second-second fixing portion SFP2-2, and a plurality of second connection portions CP2. Each of the second-first fixing portion SFP2-1 and the second-second fixing portion SFP2-2 may include the plane (e.g., may have a planar shape) defined by the first direction DR1 and the second direction DR2.

The second-first fixing portion SFP2-1 may include a first portion PT1 and a second portion PT2 extending from the first portion PT1 in the first direction DR1. The second portion PT2 may have a width smaller than a width of the first portion PT1 in the second direction DR2. When viewed in the plane, the second portion PT2 may have a larger area than the first portion PT1.

The second-second fixing portion SFP2-2 may extend longer in the second direction DR2 than in the first direction DR1. The second-second fixing portion SFP2-2 may have a rectangular shape with short sides extending in the first direction DR1 and long sides extending in the second direction DR2.

The second-second fixing portion SFP2-2 may be disposed on the first portion PT1. The second-second fixing portion SFP2-2 and the first portion PT1 may be arranged to face each other in the third direction DR3 and may overlap each other. When viewed in the plane, the second-second fixing portion SFP2-2 and the first portion PT1 may have substantially the same area. When viewed in the plane, the second-second fixing portion SFP2-2 may not overlap with (e.g., may be offset from) the second portion PT2.

The second connection portions CP2 may be disposed between the second-first fixing portion SFP2-1 and the second-second fixing portion SFP2-2 to connect the second-first fixing portion SFP2-1 and the second-second fixing portion SFP2-2. The second-first fixing portion SFP2-1 and the second-second fixing portion SFP2-2 may be moved by the second connection portions CP2 to become closer to or farther from each other in the vertical direction, for example, the third direction DR3.

For example, the second connection portions CP2 may be disposed between the second-second fixing portion SFP2-2 and the first portion PT1 and may be connected to the second-second fixing portion SFP2-2 and the first portion PT1. The second-second fixing portion SFP2-2 and the first portion PT1 may be moved by the second connection portions CP2 to become closer to or farther from each other in the third direction DR3.

The second connection portions CP2 may be fixedly connected to the second-second fixing portion SFP2-2 and may be connected to the second-first fixing portion SFP2-1 by being inserted into a plurality of second grooves GV2 defined in an upper surface of the first portion PT1 of the second-first fixing portion SFP2-1. The second grooves GV2 may be adjacent to both sides of the first portion PT1, which are opposite to each other in the second direction DR2.

The second connection portions CP2 may reciprocate in the third direction DR3 with respect to the first portion PT1 along the second grooves GV2. Small motors may be arranged in the first portion PT1 to move the second connection portions CP2 in the third direction DR3. However, the present disclosure should not be limited thereto or thereby, and according to an embodiment, the second connection portions CP2 may be implemented as bolts.

The other component to be secured of the test object may be disposed between the second-second fixing portion SFP2-2 and the first portion PT1 of the second-first fixing portion SFP2-1. The second-second fixing portion SFP2-2 and the first portion PT1 may move closer to each other by the second connection portions CP2, and thus, the second-second fixing portion SFP2-2 and the first portion PT1 may fix the other component to be secured of the test object. This configuration will be described in more detail below.

Referring to FIGS. 1, 2, 3, and 4, the rotating bar RB may extend in the first direction DR1. When viewed in the first direction DR1, the rotating bar RB may have a circular shape. The rotating bar RB may be connected to the first fixing portion FP1 and the second fixing portion FP2. The rotating bar RB may rotate about a rotation axis RX extending in (e.g., parallel to) the first direction DR1. When viewed in the first direction DR1, the rotation axis RX may be defined at a center of the rotating bar RB.

The rotating bar RB may rotate about the rotation axis RX in a clockwise direction or a counter-clockwise direction. The rotating bar RB may be fixedly connected to the first fixing portion FP1 and may be rotatably connected to the second fixing portion FP2. Accordingly, when the rotating bar RB rotates, the first fixing portion FP1 may also rotate together with the rotating bar RB about the rotation axis RX in the clockwise direction or the counter-clockwise direction. A position of the second fixing portion FP2 may be fixed by the supporter SUP described below.

The rotating bar RB may be connected to the first-first fixing portion SFP1-1 and the second-first fixing portion SFP2-1. The rotating bar RB may extend in the first direction DR1 to pass through the first-first fixing portion SFP1-1 and may be connected to the second-first fixing portion SFP2-1.

The rotating bar RB may extend outwardly from the first-first fixing portion SFP1-1 in a direction away from the second-first fixing portion SFP2-1. The rotating bar RB extending outwardly from the first-first fixing portion SFP1-1 may be connected to the driver DV.

According to the structure of the rotating bar RB, the driver DV may be connected to one of two sides of the rotating bar RB, which are opposite to each other in the first direction DR1. The other of the two sides of the rotating bar RB, which are opposite to each other in the first direction DR1, may be inserted into the second-first fixing portion SFP2-1 and may be connected to the second-first fixing portion SFP2-1.

The driver DV may be connected to the rotating bar RB to rotate the rotating bar RB. The driver DV may provide a rotational force to the rotating bar RB. The rotating bar RB may rotate in the clockwise direction or the counter-clockwise direction by the driver DV.

Referring to FIGS. 1 and 4, the protractor AGM may be disposed on one side surface of the second fixing portion FP2, which faces the first fixing portion FP1 in the first direction DR1. For example, the protractor AGM may be connected to one side surface OS of the second-second fixing portion SFP2-2 facing the first-second fixing portion SFP1-2 in the first direction DR1. The protractor AGM may be disposed on a right side of the second-second fixing portion SFP2-2 with respect to a center of the second-second fixing portion SFP2-2 in the second direction DR2.

The protractor AGM may have a fan shape. A center C of a circle having an arc ARC of the protractor AGM may be defined in the protractor AGM. An angle scale SC, provided along the arc ARC of the protractor AGM with respect to its center C, may be defined in the protractor AGM. The angle scale SC may be provided on a plane of the protractor AGM, which is flat with respect to the one side surface OS of the second-second fixing portion SFP2-2. As shown in FIG. 4, when viewed in the plane, for example, in the third direction DR3, the center C of the protractor AGM may overlap with (e.g., may be aligned with) the rotation axis RX.

The zero (0) degrees of the protractor AGM may be defined as an angle parallel to a lower surface of the second-second fixing portion SFP2-2. The zero (0) degrees of the protractor AGM may be defined corresponding to the lower surface of the second-second fixing portion SFP2-2, and angles greater than the zero (0) degrees of the protractor AGM may be defined on the protractor AGM with respect to its center C. The protractor AGM may have an angle less than 90 degrees.

Referring to FIGS. 1 and 2, the supporter SUP may be disposed under the second fixing portion FP2. The second fixing portion FP2 may be disposed on an upper surface of the supporter SUP and fixed to the supporter SUP. The second fixing portion FP2 may be connected to the supporter SUP, and the position of the second fixing portion FP2 may be fixed by the supporter SUP. For example, the second-first fixing portion SFP2-1 may be disposed on the upper surface of the supporter SUP and connected to the upper surface of the supporter SUP. According to this structure, as described above, when the first fixing portion FP1 connected to the rotating bar RB rotates by the rotating bar RB, the position of the second fixing portion FP2 may be fixed.

The first support post SP1 may extend in the third direction DR3 and may be disposed under the driver DV. The first support post SP1 may have a rectangular column shape extending in the third direction DR3, but the shape of the first support post SP1 should not be limited thereto or thereby. The driver DV may be supported by the first support post SP1.

The second support post SP2 may extend in the third direction DR3 and may be disposed on the supporter SUP. The second support post SP2 may have a rectangular column shape extending in the third direction DR3, but the shape of the second support post SP2 should not be limited thereto or thereby.

The second support post SP2 may be adjacent to the second-first fixing portion SFP2-1. The second support post SP2 may be adjacent to the other side of the second-first fixing portion SFP2-1 that is opposite to one side of the second-first fixing portion SFP2-1 facing the first-first fixing portion SFP1-1. The second support post SP2 may be adjacent to the second portion PT2 of the second-first fixing portion SFP2-1.

The extension portion EX may be connected to an upper portion of the second support post SP2. The extension portion EX may extend in the first direction DR1. When viewed in the plane, the extension portion EX may overlap the second-first fixing portion SFP2-1. The extension portion EX may have a rectangular column shape extending in the first direction DR1, but the shape of the extension portion EX should not be limited thereto or thereby. One of two sides of the extension portion EX, which are opposite to each other in the first direction DR1, may be connected to the upper portion of the support post SP2.

The camera CM may be connected to a lower surface of the extension portion EX. The camera CM may be connected to the lower surface of the extension portion EX, which is adjacent to the other of the two sides of the extension portion EX opposite to each other in the first direction DR1. The camera CM may be disposed on the first and second fixing portions FP1 and FP2. The camera CM may capture an image of the test object disposed between the first fixing portion FP1 and the second fixing portion FP2. This configuration will be described in more detail below.

FIG. 5 is a view of the first fixing portion shown in FIG. 1 in a rotated state.

As an example, FIG. 5 is a front view of the first fixing portion FP1 as viewed from the first direction DR1.

Referring to FIGS. 1 and 5, the first fixing portion FP1 may rotate about the rotation axis RX. When the protractor AGM is disposed on the right side of the second-second fixing portion SFP2-2 with respect to the center of the second-second fixing portion SFP2-2, the first fixing portion FP1 may rotate about the rotation axis RX in the counter-clockwise direction. The first-first fixing portion SFP1-1 of the first fixing portion FP1 connected to the rotating bar RB may rotate in the counter-clockwise direction.

When the first fixing portion FP1 rotates in the counter-clockwise direction, as viewed from the first direction DR1, a right portion of the first fixing portion FP1 may overlap with the scale of the protractor AGM. Therefore, a rotation angle of the first fixing portion FP1 may be measured by the protractor AGM.

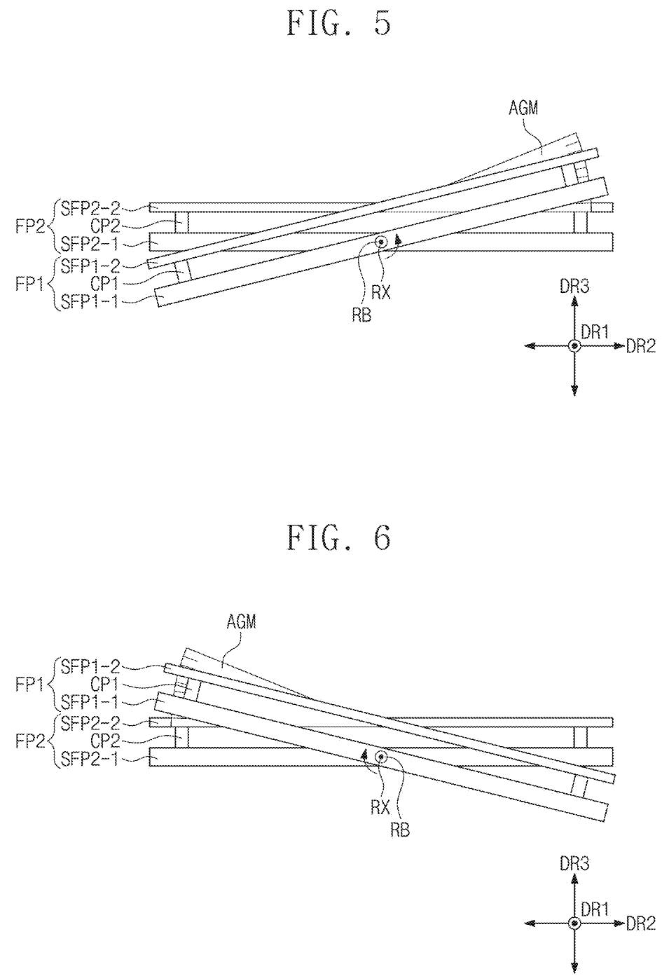

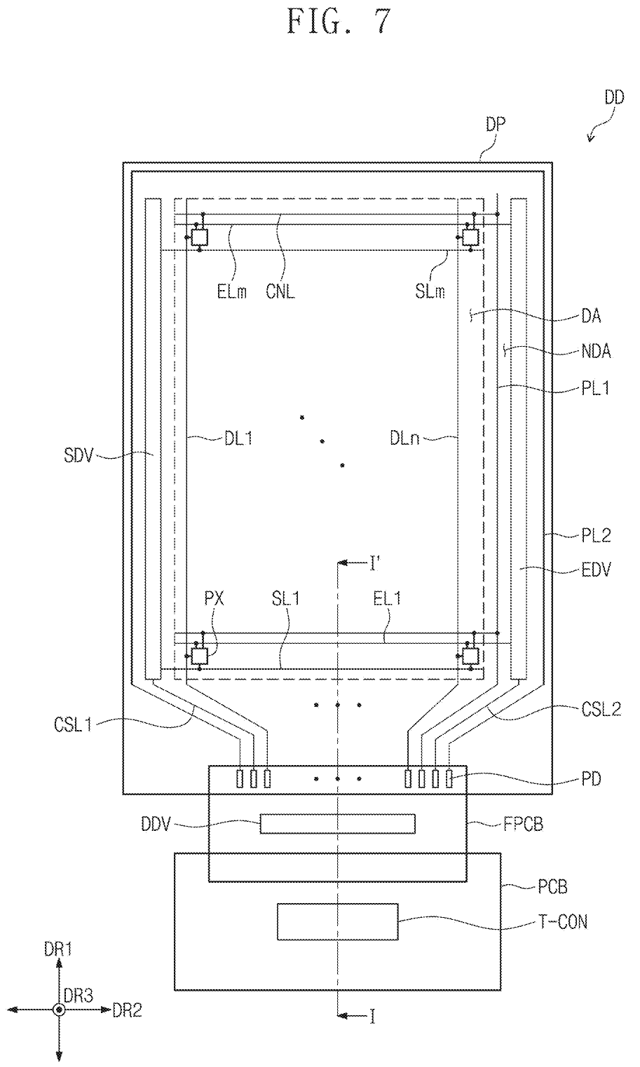

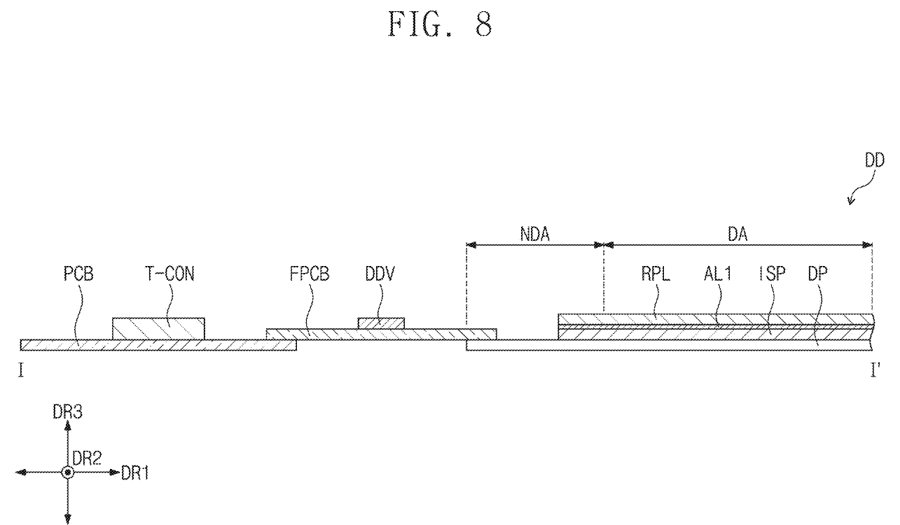

FIG. 6 is a view of a protractor according to an embodiment of the present disclosure.

As an example, FIG. 6 illustrates a front view corresponding to FIG. 5.

The protractor AGM shown in FIGS. 1 and 5 is disposed on the right side of the second-second fixing portion SFP2-2 with respect to the center of the second-second fixing portion SFP2-2; however, referring to FIG. 6, embodiments of the present disclosure should not be limited thereto or thereby. For example, as shown in FIG. 6, the protractor AGM may be disposed on a left side of the second-second fixing portion SFP2-2 with respect to the center of the second-second fixing portion SFP2-2.

When the protractor AGM is disposed on the left side of the second-second fixing portion SFP2-2 with respect to the center of the second-second fixing portion SFP2-2, the first fixing portion FP1 may rotate about the rotation axis RX in the clockwise direction. The first-first fixing portion SFP1-1 connected to the rotating bar RB may rotate in the clockwise direction.

When the first fixing portion FP1 rotates in the clockwise direction, as viewed from the first direction DR1, a left portion of the first fixing portion FP1 may overlap with the scale of the protractor AGM. Therefore, the rotation angle of the first fixing portion FP1 may be measured by the protractor AGM.

FIG. 7 is a plan view of a test object tested by a test device according to an embodiment of the present disclosure.

Referring to FIG. 7, the test object tested by the test device TD may be a display device DD. The display device DD may include a display panel DP, a scan driver SDV, a data driver DDV, a light emission driver EDV, a plurality of pads PD, a timing controller T-CON, a flexible printed circuit board FPCB, and a printed circuit board PCB.

The display panel DP may have a rectangular shape having long sides extending in the first direction DR1 and short sides extending in the second direction DR2; however, the shape of the display panel DP should not be limited thereto or thereby. The display panel DP may have a display area DA and a non-display area NDA surrounding (e.g., extending around a periphery of) the display area DA.

The display panel DP may include a plurality of pixels PX, a plurality of scan lines SL1 to SLm, a plurality of data lines DL1 to DLn, a plurality of light emission lines EL1 to ELm, first and second control lines CSL1 and CSL2, first and second power lines PL1 and PL2, and a plurality of connection lines CNL. Each of “m” and “n” as used in this paragraph is a natural number.

The pixels PX may be arranged in the display area DA. The scan driver SDV and the light emission driver EDV may be disposed in the non-display area NDA respectively adjacent to both sides of the display panel DP, which are opposite to each other in the second direction DR2.

The data driver DDV may be disposed on the flexible printed circuit board FPCB. The data driver DDV may be mounted on the flexible printed circuit board FPCB after being manufactured in the form of an integrated circuit chip.

The pads PD may be disposed on the display panel DP. The pads PD may be arranged adjacent to a lower end of the display panel DP. The pads PD may be arranged in (e.g., may be adjacent to each other in) the second direction DR2.

The scan lines SL1 to SLm may extend in the second direction DR2 and may be connected to the pixels PX and the scan driver SDV. The light emission lines EL1 to ELm may extend in the second direction DR2 and may be connected to the pixels PX and the light emission driver EDV. The data lines DL1 to DLn may extend in the first direction DR1 and may be connected to the pixels PX and the pads PD.

The flexible printed circuit board FPCB may be connected to the non-display area NDA adjacent to one of the short sides of the display panel DP. For example, the flexible printed circuit board FPCB may be connected to the pads PD. Accordingly, when viewed in the plane, the flexible printed circuit board FPCB may be connected to the non-display area NDA adjacent to the lower end of the display panel DP.

The data driver DDV may be connected to the pads PD through the flexible printed circuit board FPCB. For example, the data driver DDV may be connected to the display panel DP through the flexible printed circuit board FPCB. The pads PD connected to the data lines DL1 to DLn may be connected to the data driver DDV through the flexible printed circuit board FPCB.

The flexible printed circuit board FPCB may include a plurality of wirings connected to the data driver DDV, and the wirings may be connected to a plurality of chip pads disposed on the flexible printed circuit board FPCB. The chip pads may be connected to the pads PD, and thus, the flexible printed circuit board FPCB and the data driver DDV may be connected to the display panel DP.

The first power line PL1 may extend in the first direction DR1 and may be disposed in the non-display area NDA. The first power line PL1 may be disposed between the display area DA and the light emission driver EDV.

The connection lines CNL may extend in the second direction DR2 and may be arranged in the first direction DR1. The connection lines CNL may be connected to the first power line PL1 and the pixels PX. A first voltage may be applied to the pixels PX via the first power line PL1 and the connection lines CNL connected to the first power line PL1.

The second power line PL2 may be disposed in the non-display area NDA and may extend along the long sides of the display panel DP and the other short side at which the data driver DDV is not disposed in the display panel DP. The second power line PL2 may be disposed outside of the scan driver SDV and the light emission driver EDV.

The second power line PL2 may extend toward the display area DA and may be connected to the pixels PX. A second voltage having a level lower than that of the first voltage may be applied to the pixels PX via the second power line PL2.

The first control line CSL1 may be connected to the scan driver SDV and may extend toward the lower end of the display panel DP. The second control line CSL2 may be connected to the light emission driver EDV and may extend toward the lower end of the display panel DP.

The data lines DL1 to DLn, the first power line PL1, the second power line PL2, the first control line CSL1, and the second control line CSL2 may be connected to the pads PD, respectively.

The timing controller T-CON may be disposed on the printed circuit board PCB. The timing controller T-CON may be manufactured in the form of an integrated circuit chip and mounted on the printed circuit board PCB.

The printed circuit board PCB may be connected to one of two sides of the flexible printed circuit board FPCB, which are opposite to each other in the first direction DR1. The display panel DP may be connected to the other of the two sides of the flexible printed circuit board FPCB, which are opposite to each other in the first direction DR1.

The timing controller T-CON may be connected to the data driver DDV through the printed circuit board PCB. In addition, the timing controller T-CON may be connected to the scan driver SDV and the light emission driver EDV through the printed circuit board PCB and the flexible printed circuit board FPCB. The timing controller T-CON may control the operations of the scan driver SDV, the data driver DDV, and the light emission driver EDV.

Because the flexible printed circuit board FPCB is disposed on the display panel DP and the printed circuit board PCB, a portion of the display panel DP and a portion of the printed circuit board PCB, which overlap with the flexible printed circuit board FPCB, may be covered by the flexible printed circuit board FPCB and may not be visible from the outside. However, in FIG. 7, to more clearly illustrate the configuration, the portion of the display panel DP, for example, the pads PD, and the portion of the printed circuit board PCB, for example, an edge of the printed circuit board PCB, which are covered by the flexible printed circuit board FPCB, are additionally shown under the assumption that the flexible printed circuit board FPCB is transparent.

The display device DD may further include a voltage generator to generate the first and second voltages. The voltage generator may be disposed on the printed circuit board PCB.

The scan driver SDV may generate a plurality of scan signals, and the scan signals may be applied to the pixels PX through the scan lines SL1 to SLm. The data driver DDV may generate a plurality of data voltages, and the data voltages may be applied to the pixels PX through the data lines DL1 to DLn. The light emission driver EDV may generate a plurality of light emission signals, and the light emission signals may be applied to the pixels PX through the light emission lines EL1 to ELm.

The pixels PX may receive the data voltages in response to the scan signals. The pixels PX may emit light having a luminance corresponding to the data voltages in response to the light emission signals, and thus, the images may be displayed.

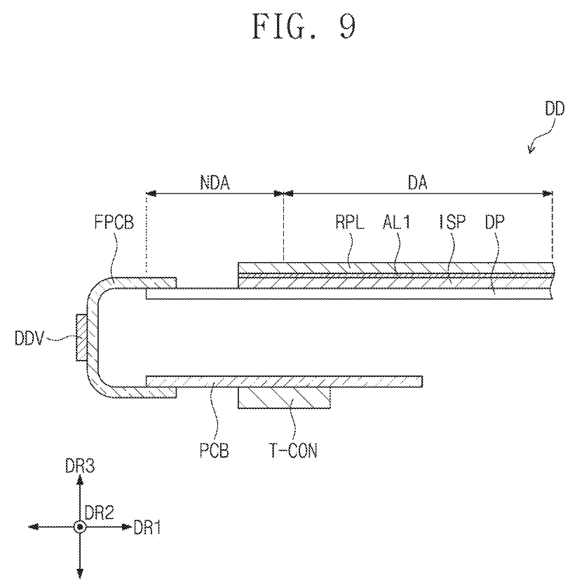

FIG. 8 is a cross-sectional view taken along the line I-I’ in FIG. 7. FIG. 9 is a view of the flexible printed circuit board shown in FIG. 8 in a bent state.

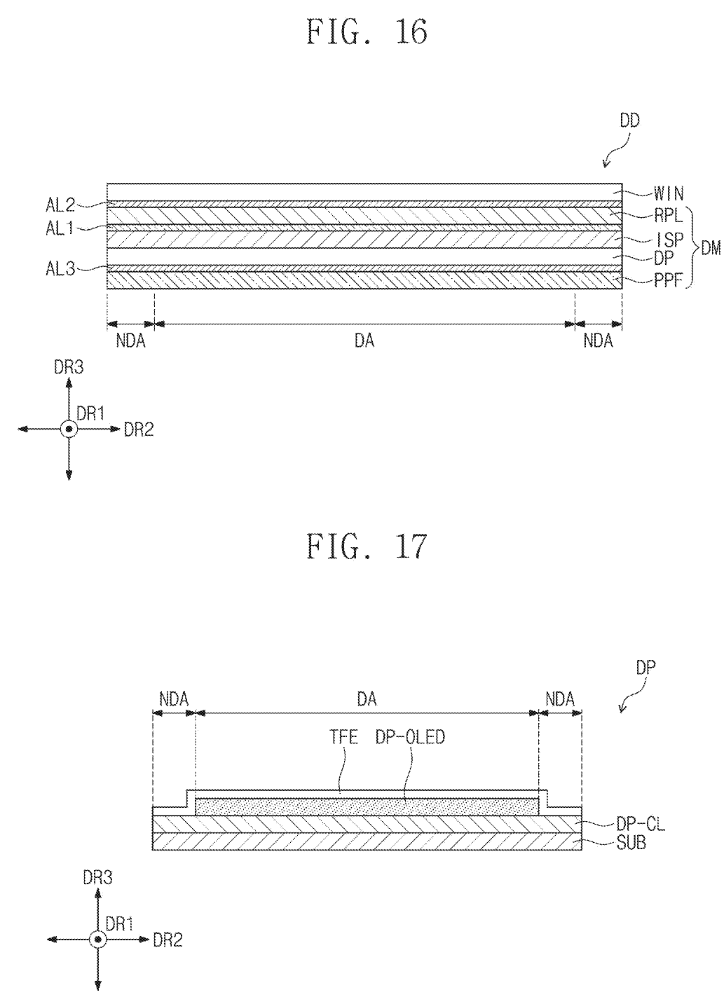

Referring to FIG. 8, the display device DD may include an input sensing part ISP disposed on the display panel DP, an anti-reflective layer RPL disposed on the input sensing part ISP, and a first adhesive layer AL1 disposed between the input sensing part ISP and the anti-reflective layer RPL. The functions of the input sensing part ISP, the anti-reflective layer RPL, and the first adhesive layer AL1 will be described in detail below with reference to FIG. 16.

When viewed in the plane, the input sensing part ISP and the anti-reflective layer RPL may overlap the display area DA and may extend to a portion of the non-display area NDA adjacent to the display area DA.

One of two sides of the flexible printed circuit board FPCB, which are opposite to each other in the first direction DR1, may be disposed on one side of the printed circuit board PCB and connected to the printed circuit board PCB. The other of the two sides of the flexible printed circuit board FPCB, which are opposite to each other in the first direction DR1, may be disposed on one side of the display panel DP and connected to the display panel DP. The one side of the display panel DP and the one side of the printed circuit board PCB may face each other in the first direction DR1.

The data driver DDV may be disposed on the flexible printed circuit board FPCB, and the timing controller T-CON may be disposed on the printed circuit board PCB. The data driver DDV may be manufactured in the form of the integrated circuit chip and mounted on the flexible printed circuit board FPCB. The timing controller T-CON may be manufactured in the form of the integrated circuit chip and mounted on the printed circuit board PCB.

The printed circuit board PCB and the display panel DP may be a rigid type. The flexible printed circuit board FPCB may have flexible properties. The flexible printed circuit board FPCB may be bent, and thus, the timing controller T-CON and the printed circuit board PCB may be disposed under the display panel DP. Accordingly, when viewing the display panel DP from the above of the display panel DP, the timing controller T-CON and the printed circuit board PCB may not be visible from the outside.

During the manufacturing process of the display device DD, the printed circuit board PCB, the display panel DP, and the flexible printed circuit board FPCB may be transferred to a process chamber for subsequent processes while being connected to each other. During the transfer, due to ambient vibrations or the like, the flexible printed circuit board FPCB may be bent in various directions, rather than being disposed on (e.g., rather than remaining on) the same plane as the display panel DP and the printed circuit board PCB. For example, the flexible printed circuit board FPCB may be bent such that the flexible printed circuit board FPCB is twisted about the rotation axis parallel to the first direction DR1.

In addition, during the transfer, a protective film to protect the printed circuit board PCB, the display panel DP, and the flexible printed circuit board FPCB may be disposed on the printed circuit board PCB, the display panel DP, and the flexible printed circuit board FPCB. When a subsequent process is performed, the protective film may be separated from the printed circuit board PCB, the display panel DP, and the flexible printed circuit board FPCB. When the protective film is separated from the printed circuit board PCB, the display panel DP, and the flexible printed circuit board FPCB, the flexible printed circuit board FPCB may be bent. For example, the flexible printed circuit board FPCB may be bent such that the flexible printed circuit board FPCB is twisted about the rotation axis parallel to the first direction DR1.

According to an embodiment of the present disclosure, the test device TD may perform a twist test on the flexible printed circuit board FPCB. The test device TD may measure a twist angle of the flexible printed circuit board FPCB at which the flexible printed circuit board FPCB may be damaged. This operation will be described in more detail below.

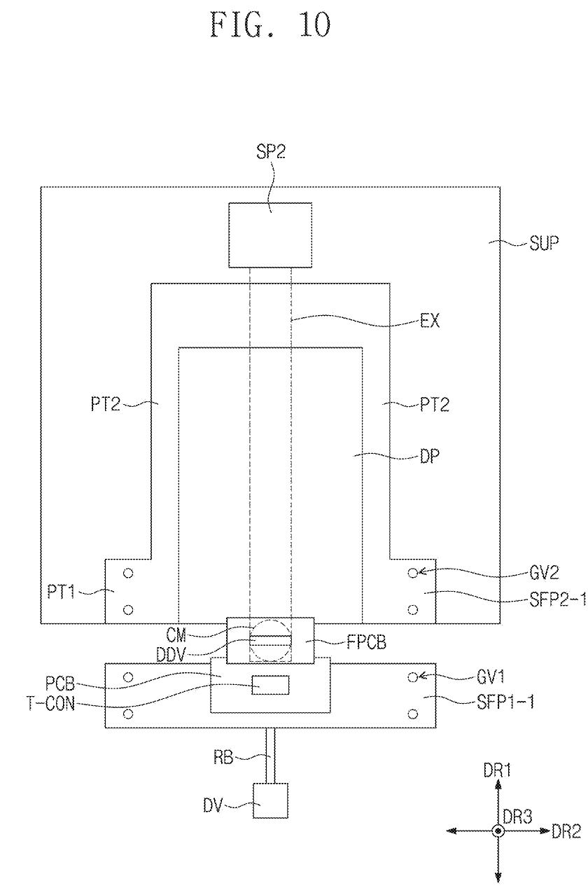

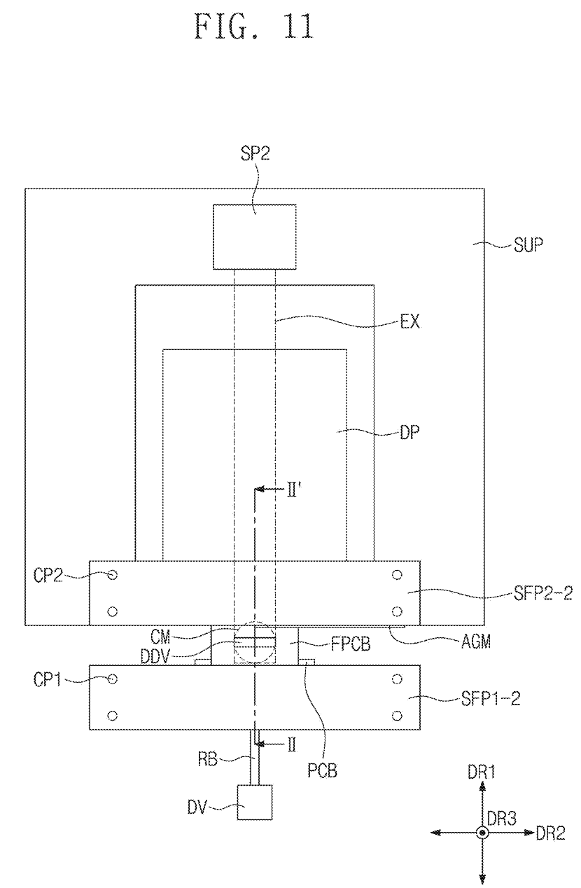

FIGS. 10 and 11 are views of the display panel, the flexible printed circuit board, and the printed circuit board shown in FIG. 9 placed on the test device shown in FIG. 1.

As an example, FIGS. 10 and 11 are plan views of the test device TD as viewed from above. In addition, in FIGS. 10 and 11, the extension portion EX and the camera CM are illustrated by dotted lines to clearly illustrate the configuration of the first and second fixing portions FP1 and FP2.

Referring to FIG. 10, the printed circuit board PCB may be disposed on the first-first fixing portion SFP1-1, and the display panel DP may be disposed on the second-first fixing portion SFP2-1. The input sensing part ISP and the anti-reflective layer RPL shown in FIG. 8 may also be disposed on the second-first fixing portion SFP2-1. When viewed in the plane, the flexible printed circuit board FPCB may be disposed between the first-first fixing portion SFP1-1 and the second-first fixing portion SFP2-1.

The printed circuit board PCB may be supported by the first-first fixing portion SFP1-1, and the display panel DP may be supported by the second-first fixing portion SFP2-1. The display panel DP may be disposed on the first portion PT1 and the second portion PT2. A portion of the display panel DP, which is adjacent to the flexible printed circuit board FPCB, may be disposed on the first portion PT1. The other portion of the display panel DP may be disposed on the second portion PT2.

Referring to FIG. 11, the first-second fixing portion SFP2-1 may be disposed on the printed circuit board PCB. The second-second fixing portion SFP2-2 may be disposed on the portion of the display panel DP, which is disposed on the first portion PT1. Thus, the printed circuit board PCB may be fixed by the first-first fixing portion SFP1-1 and the first-second fixing portion SFP1-2, and the display panel DP may be fixed by the second-first fixing portion SFP2-1 and the second-second fixing portion SFP2-2.

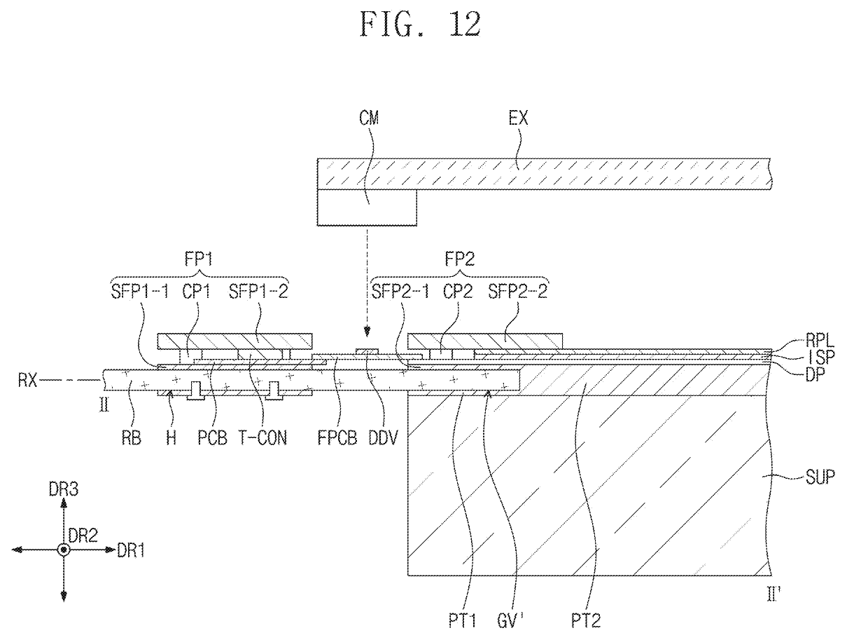

FIG. 12 is a cross-sectional view taken along the line II-II’ in FIG. 11.

Referring to FIG. 12, the first fixing portion FP1 may secure the printed circuit board PCB. The printed circuit board PCB may be disposed between the first-first fixing portion SFP1-1 and the first-second fixing portion SFP1-2. The first-first fixing portion SFP1-1 and the first-second fixing portion SFP1-2 may be moved closer to each other by the first connection portions CP1, and thus, the printed circuit board PCB may be fixed. The first-first fixing portion SFP1-1 and the first- second fixing portion SFP1-2 may be in contact with the printed circuit board PCB and the timing controller T-CON from below and above, respectively, to secure the printed circuit board PCB.

The second fixing portion FP2 may secure the display panel DP. The display panel DP may be disposed between the second-first fixing portion SFP2-1 and the second-second fixing portion SFP2-2. For example, the portion of the display panel DP, which overlaps with the first portion PT1, may be disposed between the first portion PT1 and the second-second fixing portion SFP2-2. Substantially, the display panel DP, the input sensing part ISP, and the anti-reflective layer RPL may be disposed and fixed between the first portion PT1 and the second-second fixing portion SFP2-2. For convenience of explanation, the first adhesive layer AL1 shown in FIG. 8 is omitted in FIG. 12.

The second-first fixing portion SFP2-1 and the second-second fixing portion SFP2-2 may be moved closer to each other by the second connection portions CP2, and thus, the display panel DP may be fixed. For example, the portion of the display panel DP, which overlaps with the first portion PT1, may be fixed by the first portion PT1 and the second-second fixing portion SFP2-2. The first portion PT1 and the second-second fixing portion SFP2-2 may be in contact with the display panel DP and the anti-reflective layer RPL from below and above, respectively, to secure the display panel DP.

The protractor AGM, which is connected to the second-second fixing portion SFP2-2, may be disposed on the display panel DP. The rotating bar RB, which is connected to the first-first fixing portion SFP1-1 and the second-first fixing portion SFP2-1, may be disposed under the printed circuit board PCB, the flexible printed circuit board FPCB, and the display panel DP.

The rotating bar RB may pass through a hole (e.g., an opening) H defined through the first-first fixing portion SFP1-1 and may be inserted into a groove GV’ defined in the second-first fixing portion SFP2-1. The hole H and the groove GV’ may extend in the first direction DR1.

The rotating bar RB may be coupled to the first-first fixing portion SFP1-1 by a plurality of pin units (e.g., pins) PN. The pin units PN may be disposed under the first-first fixing portion SFP1-1 and may be inserted into the first-first fixing portion SFP1-1 and the rotating bar RB in the form of a screw to couple the first-first fixing portion SFP1-1 and the rotating bar RB. Due to this structure, the rotating bar RB may be fixedly coupled to the first fixing portion FP1.

The rotating bar RB may be inserted into the groove GV’ of the second-first fixing portion SFP2-1, and thus, may be rotatably coupled to the second-first fixing portion SFP2-1. As an example, the rotating bar RB may be coupled to the second-first fixing portion SFP2-1 in the form of a screw to rotate with respect to the second-first fixing portion SFP2-1, but the present disclosure should not be limited thereto or thereby. According to embodiments, the rotating bar RB may be coupled in various forms to rotate with respect to the second-first fixing portion SFP2-1. As described above, because the position of the second-first fixing portion SFP2-1 is fixed by the supporter SUP, the rotating bar RB may rotate while the second-first fixing portion SFP2-1 remains fixed.

Because the rotating bar RB is connected to the first fixing portion FP1 and the second fixing portion FP2, the first fixing portion FP1 and the second fixing portion FP2 may be disposed at the same rotation axis RX. Because the protractor AGM is disposed on the second fixing portion FP2, which is fixed by the supporter SUP, and the first fixing portion FP1 rotates, the rotation angle may be easily measured.

The camera CM may be disposed on the flexible printed circuit board FPCB. Therefore, when viewed in the plane, the camera CM may be disposed between the first fixing portion FP1 and the second fixing portion FP2. The camera CM may capture an image of the flexible printed circuit board FPCB to determine whether or not the flexible printed circuit board FPCB is damaged.

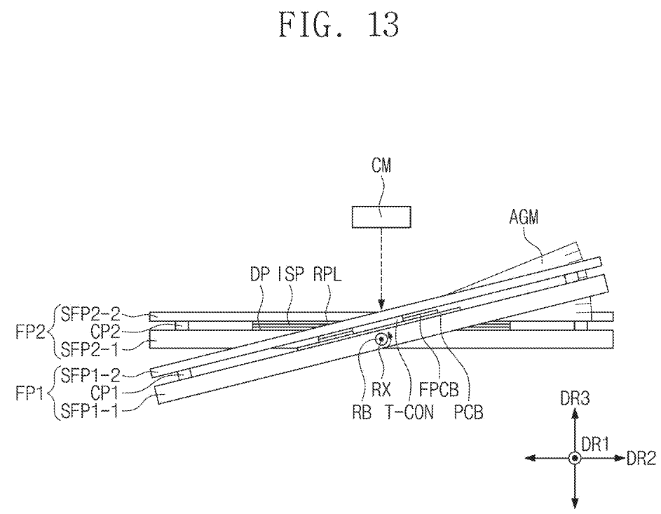

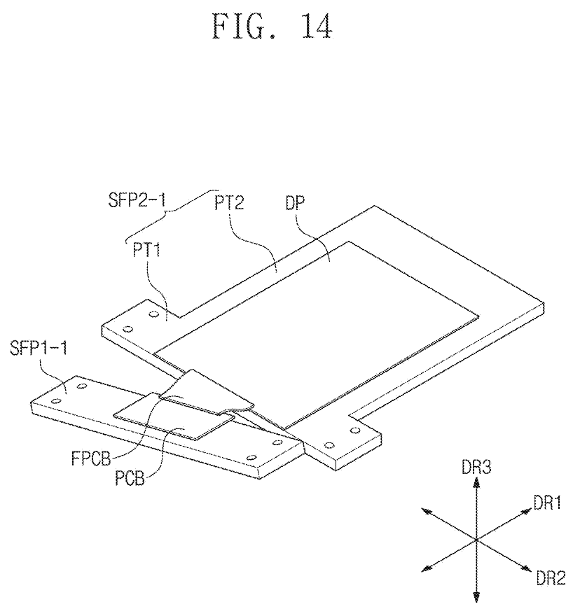

FIG. 13 is a view illustrating an operation of performing a twist test on the flexible printed circuit board using the test device according to an embodiment of the present disclosure. FIG. 14 is a perspective view of the flexible printed circuit board shown in FIG. 13 in a twisted state.

For instance, FIG. 13 illustrates a front view of the first fixing portion FP1 when viewed from the first direction DR1. In addition, in FIG. 14, the first-first fixing portion SFP1-1, the second-first fixing portion SFP2-1, the display panel DP, the flexible printed circuit board FPCB, and the printed circuit board PCB are illustrated while other components are omitted to more clearly show the twisted state of the flexible printed circuit board FPCB.

Referring to FIGS. 13 and 14, the printed circuit board PCB may be fixed by using the first fixing portion FP1, and the display panel DP may be fixed by using the second fixing portion FP2. When viewed from the first direction DR1, the printed circuit board PCB may be disposed between the first connection portions CP1. When viewed from the first direction DR1, the display panel DP, the input sensing part ISP, and the anti-reflective layer RPL may be disposed between the second connection portions CP2.

The first fixing portion FP1 may gradually rotate by using (e.g., according to) the rotating bar RB. The first fixing portion FP1 may rotate in the counter-clockwise direction about the rotation axis RX. As the first fixing portion FP1 gradually rotates, the flexible printed circuit board FPCB may be bent. As the first fixing portion FP1 rotates about the rotation axis RX, the flexible printed circuit board FPCB may be bent in a twisted manner (e.g., may twist) around the rotation axis RX.

The camera CM may capture the state of the flexible printed circuit board FPCB as it is twisted and bent. As the rotation angle of the first fixing portion FP1 gradually increases, cracks may occur in the flexible printed circuit board FPCB, and thus, the flexible printed circuit board FPCB may be damaged. When the damaged state of the flexible printed circuit board FPCB is observed through the camera CM, the rotational operation of the first fixing portion FP1 may be stopped.

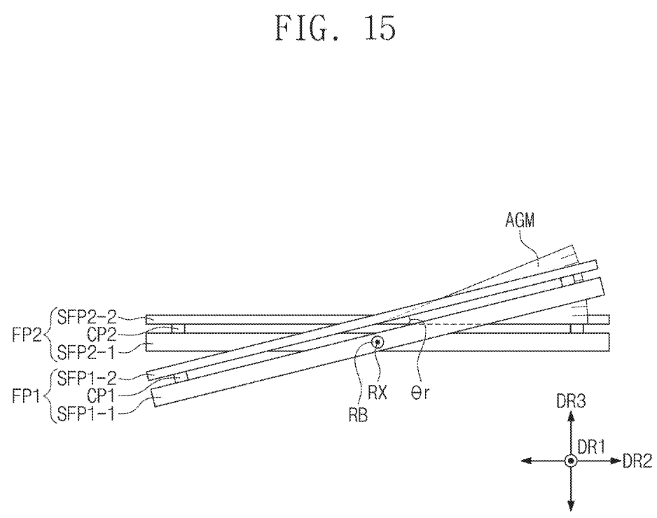

FIG. 15 is a view of the first fixing portion illustrating a state of where its rotational operation is stopped due to damage to the flexible printed circuit board as shown in FIG. 14.

As an example, FIG. 15 illustrates the first and second fixing portions FP1 and FP2 with the display panel DP, flexible printed circuit board FPCB, and printed circuit board PCB omitted for clarity.

Referring to FIG. 15, when the flexible printed circuit board FPCB is damaged, a rotation angle (θr) of the first fixing portion FP1 may be identified through the protractor AGM. The rotation angle (θr) may be defined as the twist angle of the flexible printed circuit board FPCB at which the flexible printed circuit board FPCB is damaged. In addition, the rotation angle (θr) may be defined as a minimum angle at which the flexible printed circuit board FPCB may be damaged. Hereinafter, the rotation angle (θr) is referred to as the “damage angle.”

When the flexible printed circuit board FPCB is twisted by an angle smaller than the damage angle (θr), the flexible printed circuit board FPCB may not be damaged. When the flexible printed circuit board FPCB is twisted by an angle greater than or equal to the damage angle (θr), the flexible printed circuit board FPCB may be damaged. As the damage angle (θr) becomes larger, the durability of the flexible printed circuit board FPCB may increase, and as the damage angle (θr) becomes smaller, the durability of the flexible printed circuit board FPCB may decrease.

The twist test may be performed on the flexible printed circuit board FPCB by using the test device TD according to an embodiment of the present disclosure, and thus, the twist angle at which the flexible printed circuit board FPCB is damaged, that is, the damage angle, may be measured. Thus, the durability of the flexible printed circuit board FPCB may be measured.

Tests may be performed on a plurality of flexible printed circuit boards FPCB to evaluate the durability of various types of flexible printed circuit boards FPCB. The damage angles at which the flexible printed circuit boards FPCB are damaged may be measured, and the measured results may be stored as a database in a storage unit. Accordingly, when the display device DD is manufactured, an appropriate flexible printed circuit board FPCB may be selected based on the database to manufacture the display device DD.

FIG. 16 is a cross-sectional view of the display device manufactured by using the same flexible printed circuit board as the tested flexible printed circuit board.

When the display device DD is manufactured, a highly durable flexible printed circuit board FPCB may be used in accordance with the above-mentioned test. For instance, FIG. 16 is the cross-sectional view of the display device DD as viewed from the first direction DR1.

Referring to FIG. 16, the display device DD may include the display panel DP, the input sensing part ISP, the anti-reflective layer RPL, a window WIN, a panel protective film PPF, and first, second, and third adhesive layers AL1, AL2, and AL3. The display panel DP, the input sensing part ISP, the anti-reflective layer RPL, and the panel protective film PPF may be defined as a display module DM. The flexible printed circuit board FPCB may be connected to the display panel DP as illustrated in the planar structure of FIG. 7. As an example, the flexible printed circuit board FPCB is omitted in FIG. 16.

The object tested by the above-mentioned test device TD may substantially be the display module DM of the display device DD. For convenience of explanation, the panel protective film PPF is omitted in the previous drawings with respect to the test object. After the display module DM of the display device DD is tested by the above-mentioned test device TD, the window WIN may be provided on the anti-reflective layer RPL to complete the manufacturing of the display device DD.

The display panel DP may be a light-emitting type display panel. For example, the display panel DP may be an organic light emitting display panel or an inorganic light emitting display panel. A light emitting layer of the organic light emitting display panel may include an organic light emitting material. A light emitting layer of the inorganic light emitting display panel may include a quantum dot or a quantum rod. Hereinafter, the organic light emitting display panel will be described as a representative example of the display panel DP.

The input sensing part ISP may be disposed on the display panel DP. The input sensing part ISP may include a plurality of sensing portions to sense an external input by a capacitive method. The input sensing part ISP may be manufactured directly on the display panel DP when the display device DD is manufactured, however, it should not be limited thereto or thereby. According to an embodiment, the input sensing part ISP may be attached to the display panel DP by an adhesive layer after being manufactured separately from the display panel DP.

The anti-reflective layer RPL may be disposed on the input sensing part ISP. The anti-reflective layer RPL may be defined as an external light reflection preventing film. The anti-reflective layer RPL may reduce a reflectance with respect to external light incident to the display panel DP from above the display device DD. The external light may not be visible to the user due to the anti-reflective layer RPL.

When the external light traveling to the display panel DP is reflected by the display panel DP and provided back to the user, the user may perceive the external light, like a mirror. The anti-reflective layer RPL may include color filters that display the same colors as those of pixels of the display panel DP to prevent the above-mentioned phenomenon.

The color filters may filter the external light into the same colors as the pixels. In such an embodiment, the external light may not be visible to the user. However, the present disclosure should not be limited thereto or thereby, and the anti-reflective layer RPL may include a retarder and/or a polarizer to reduce the reflectance with respect to the external light.

The window WIN may be disposed on the anti-reflective layer RPL. The window WIN may protect the display panel DP, the input sensing part ISP, and the anti-reflective layer RPL from external scratches and impacts.

The panel protective film PPF may be disposed under the display panel DP. The panel protective film PPF may protect a lower portion of the display panel DP. The panel protective film PPF may include a flexible plastic material, such as polyethylene terephthalate (PET).

The first adhesive layer AL1 may be disposed between the input sensing part ISP and the anti-reflective layer RPL. The input sensing part ISP and the anti-reflective layer RPL may be attached to each other by the first adhesive layer AL1. The second adhesive layer AL2 may be disposed between the window WIN and the anti-reflective layer RPL, and the window WIN and the anti-reflective layer RPL may be attached to each other by the second adhesive layer AL2. The third adhesive layer AL3 may be disposed between the display panel DP and the panel protective film PPF, and the display panel DP and the panel protective film PPF may be attached to each other by the third adhesive layer AL3.

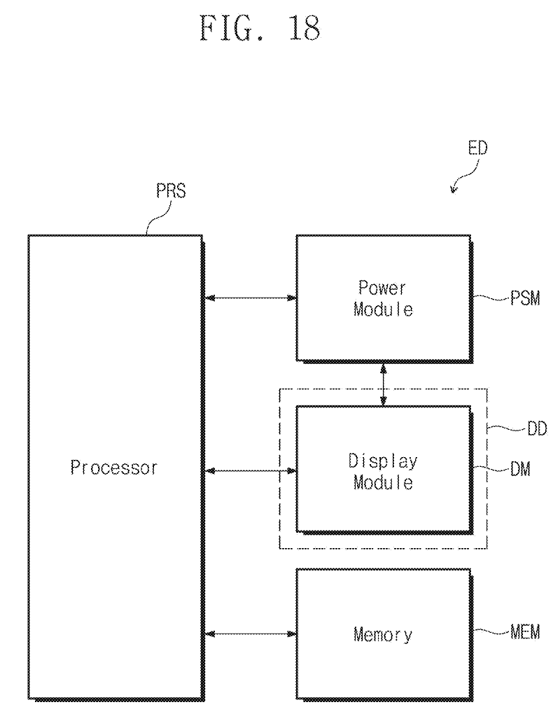

FIG. 17 is a cross-sectional view of the display panel shown in FIG. 16.

As an example, FIG. 17 illustrates the cross-sectional view of the display panel DP as viewed from the first direction DR1.

Referring to FIG. 17, the display panel DP may include a substrate SUB, a circuit element layer DP-CL disposed on the substrate SUB, a display element layer DP-OLED disposed on the circuit element layer DP-CL, and an encapsulation layer TFE disposed on the display element layer DP-OLED.

The substrate SUB may have the display area DA and the non-display area NDA around the display area DA. The substrate SUB may be a rigid type and may include a glass substrate. The display element layer DP-OLED may be disposed in the display area DA.

A plurality of pixels may be disposed in the circuit element layer DP-CL and the display element layer DP-OLED. Each pixel may include a transistor disposed in the circuit element layer DP-CL and a light emitting element disposed in the display element layer DP-OLED and connected to the transistor.

The encapsulation layer TFE may be disposed on the circuit element layer DP-CL to cover the display element layer DP-OLED. The encapsulation layer TFE may protect the pixels from moisture, oxygen, and a foreign substance.

FIG. 18 is a block diagram describing an electronic device including the display device shown in FIG. 16.

Referring to FIG. 18, the electronic device ED may include the display device DD to provide the image to the user and may further include modules or devices having additional functions in addition to the display device DD. The electronic device ED may include the display module DM, a processor PRS, a memory MEM, and a power module PSM, and the display device DD may include the display module DM.

The processor PRS may include at least one of a central processing unit (CPU), an application processor (AP), a graphics processing unit (GPU), a communication processor (CP), an image signal processor (ISP), and a controller. The processor PRS may process image signals and provide the processed image signals to the display device DD, and the display device DD may generate images corresponding to the image signals.

In an embodiment, the processor PRS may be divided into two or more components from a functional or structural perspective. For example, the processor PRS may include a main processor in the form of a first driving chip that includes the central processing unit and an auxiliary processor in the form of a second driving chip that includes the controller configured to receive image signals from the main processor and to process the image signals according to an interface specification of the display module DM.

The memory MEM may store data information required for the operation of the processor PRS or the display module DM. When the processor PRS executes an application stored in the memory MEM, an image signal and/or an input control signal may be transmitted to the display module DM, and the display module DM may process the received signals to output image information through a display screen.

The power module PSM may include a power supply module, such as a power adapter or a battery device, and a power conversion module that converts power supplied by the power supply module to generate power required for the operation of the electronic device ED. The power module PSM may supply the power to the display module DM and the processor PRS.

At least one of the components of the electronic device ED may be included in the display device DD. In addition, among individual modules that are functionally included within a single module, some may be included in the display device DD while others may be provided separately from the display device DD. As an example, the display device DD may include the display module DM, and the processor PRS, the memory MEM, and the power module PSM may be provided as separate devices within the electronic device ED rather than being included in the display device.

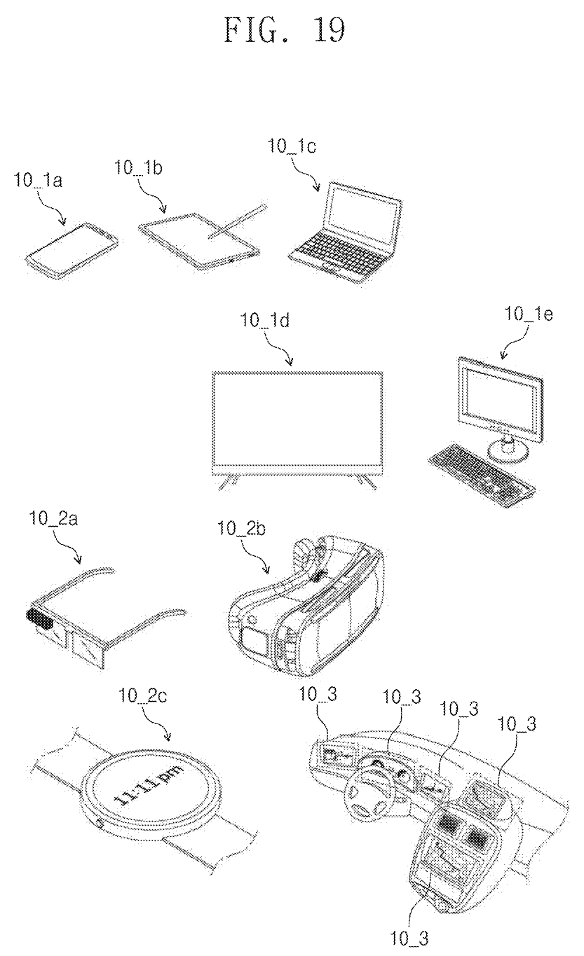

FIG. 19 is a schematic view illustrating electronic devices according to various embodiments.

Referring to FIG. 19, the display device DD may be applied to various electronic devices. As an example, various electronic devices to which the display device DD is applied may include electronic devices to display images, such as a smartphone 10_1a, a tablet PC 10_1b, a laptop computer 10_1c, a television 10_1d, a desktop monitor 10_1e, etc.

In addition, various electronic devices to which the display device DD is applied may include wearable electronic devices, such as a smart glasses 10_2a, a head-mounted display 10_2b, a smartwatch 10_2c, etc. Further, various electronic devices to which the display device DD is applied may include in-vehicle electronic devices 10_3, such as an instrument panel, a center fascia, a dashboard-mounted center information display (CID), or a room mirror display.

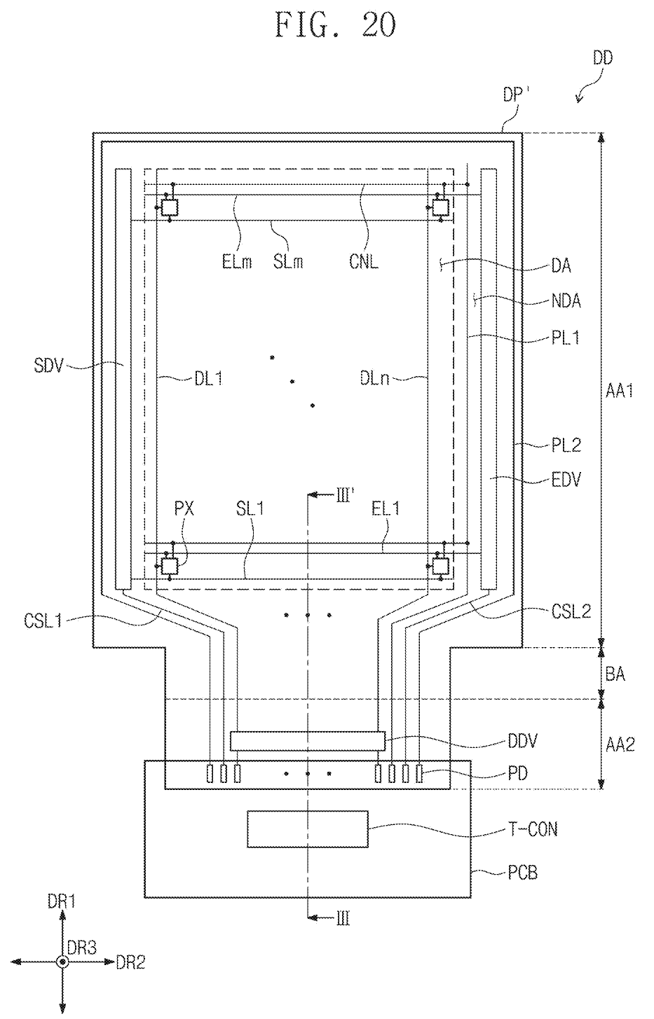

FIG. 20 is a view illustrating a test object according to an embodiment of the present disclosure.

As an example, FIG. 20 is a plan view corresponding to FIG. 7. Hereinafter, the configuration shown in FIG. 20 will be described, primarily focusing on the components and configurations that are different from those shown in FIG. 7.

Referring to FIG. 20, pixels PX, scan lines SL1 to SLm, data lines DL1 to DLn, light emission lines EL1 to ELm, first and second control lines CSL1 and CSL2, first and second power lines PL1 and PL2, connection lines CNL, a scan driver SDV, and a light emission driver EDV may be substantially the same as those of FIG. 7.

A display panel DP’ may be a flexible display panel. For example, the display panel DP’ may include a flexible substrate including a flexible plastic material, such as polyimide, and a plurality of pixels arranged on the flexible substrate.

The display panel DP’ may have a first area AA1, a second area AA2, and a bending area BA disposed between the first area AA1 and the second area AA2. The first area AA1, the bending area BA, and the second area AA2 may be continuously arranged in the first direction DR1. The bending area BA may extend in the second direction DR2. The bending area BA may extend from the first area AA1 to the first direction DR1, and the second area AA2 may extend from the bending area BA to the first direction DR1.

The first area AA1 may include long sides extending in the first direction DR1 and opposite to each other in the second direction DR2. The bending area BA and the second area AA2 may have a length smaller than a length of the first area AA1 in the second direction DR2.

The first area AA1 may include a display area DA and a non-display area NDA around the display area DA. The non-display area NDA may surround (e.g., may extend around a periphery of) the display area DA. Images may be displayed through the display area DA and may not be displayed through the non-display area NDA. The images may not be displayed through the second area AA2 and the bending area BA.

The pixels PX may be disposed in the display area DA of the first area AA1. The scan driver SDV and the light emission driver EDV may be disposed in the non-display area NDA adjacent to the long sides of the first area AA1. A data driver DDV may be disposed in the second area AA2. The data driver DDV may be manufactured in the form of an integrated circuit chip and mounted on the second area AA2.

A printed circuit board PCB may be connected to pads PD. A timing controller T-CON may be manufactured as an integrated circuit chip and mounted on the printed circuit board PCB. The timing controller T-CON may be connected to the pads PD through the printed circuit board PCB.

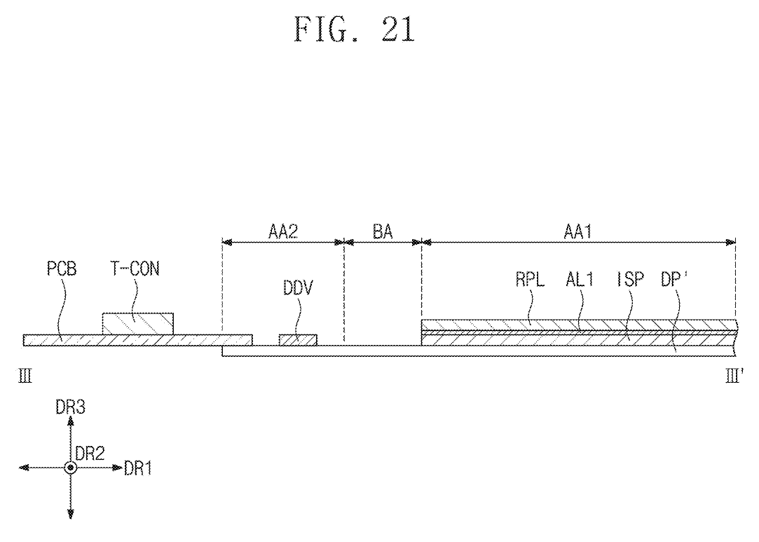

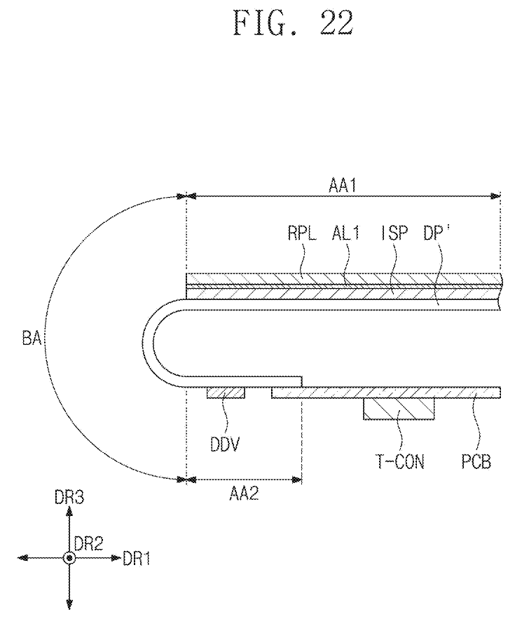

FIG. 21 is a cross-sectional view taken along the line III-III’ in FIG. 20. FIG. 22 is a view of the bending area illustrated in FIG. 21 in a bent state.

Referring to FIGS. 21 and 22, the printed circuit board PCB may be disposed on one side of the second area AA2 and connected to the second area AA2. Similar to the structure illustrated in FIG. 7, an input sensing part ISP, a first adhesive layer AL1, and an anti-reflective layer RPL may be disposed on the display panel DP’. The input sensing part ISP, the first adhesive layer AL1, and the anti-reflective layer RPL may be disposed on the first area AA1.

When the bending area BA is bent, the second area AA2 and the printed circuit board PCB may be disposed under the first area AA1. Accordingly, the data driver DDV disposed on the second area AA2 and the timing controller T-CON disposed on the printed circuit board PCB may be located under the first area AA1 and may not be visible from the outside.

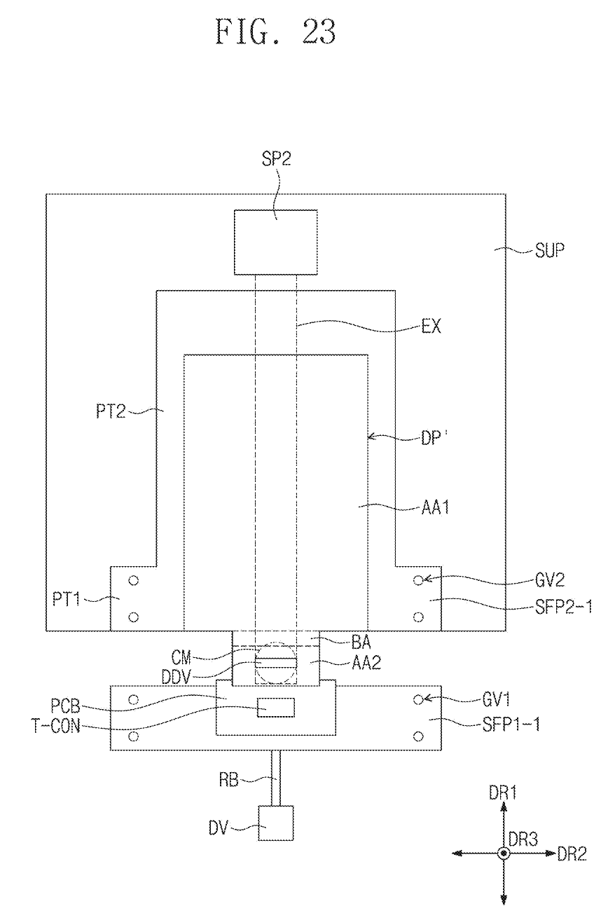

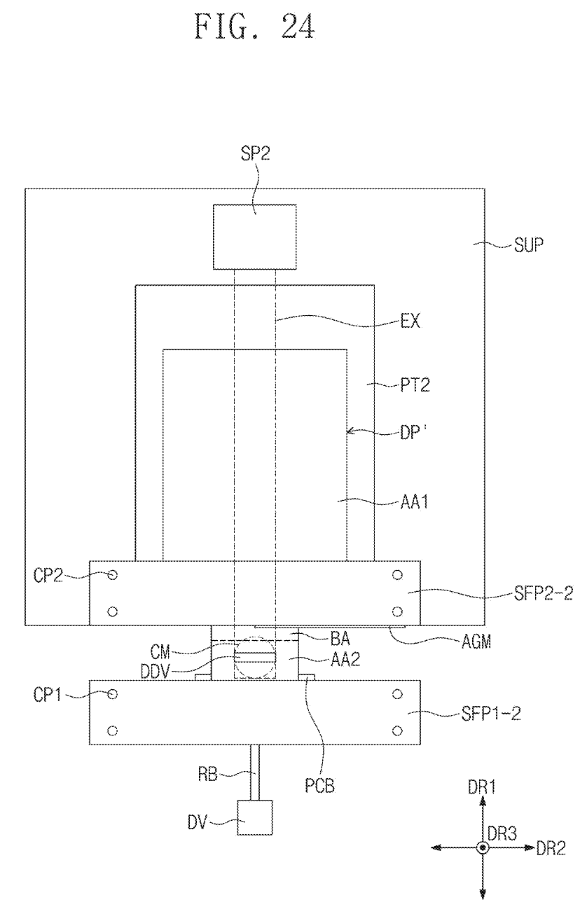

FIGS. 23 and 24 are views illustrating a structure in which the display panel and the printed circuit board shown in FIG. 21 are placed on the test device illustrated in FIG. 1.

As an example, FIGS. 23 and 24 are plan views corresponding to FIGS. 10 and 11, respectively.

Referring to FIG. 23, the printed circuit board PCB may be disposed on the first-first fixing portion SFP1-1, and the first area AA1 of the display panel DP may be disposed on the second-first fixing portion SFP2-1. When viewed in the plane, the bending area BA and the second area AA2 may be disposed between the first-first fixing portion SFP1-1 and the second-first fixing portion SFP2-1.

The printed circuit board PCB may be supported by the first-first fixing portion SFP1-1, and the first area AA1 of the display panel DP may be supported by the second-first fixing portion SFP2-1. The first area AA1 may be disposed on the first portion PT1 and the second portion PT2. A portion of the first area AA1, which is adjacent to the bending area BA, may be disposed on the first portion PT1. The other portion of the first area AA1 may be disposed on the second portion PT2.

Referring to FIG. 24, the first-second fixing portion SFP1-2 may be disposed on the printed circuit board PCB. The second-second fixing portion SFP2-2 may be disposed on the portion of the first area AA1, which is disposed on the first portion PT1. The first-second fixing portion SFP1-2 may move toward the first-first fixing portion SFP1-1 by the above-mentioned first connection portions CP1, and the printed circuit board PCB may be fixed by the first-first fixing portion SFP1-1 and the first-second fixing portion SFP1-2. In addition, the second-second fixing portion SFP2-2 may move toward the second-first fixing portion SFP2-1 by the above-mentioned second connection portions CP2, and the first area AA1 of the display panel DP may be fixed by the second-first fixing portion SFP2-1 and the second-second fixing portion SFP2-2.

Accordingly, the first fixing portion FP1 may fix the first area AA1, and the second fixing portion FP2 may fix the printed circuit board PCB. Then, as described in FIG. 13, the twist test for the second area AA2 and the bending area BA may be performed while the first fixing portion FP1 rotates by the rotating bar RB.

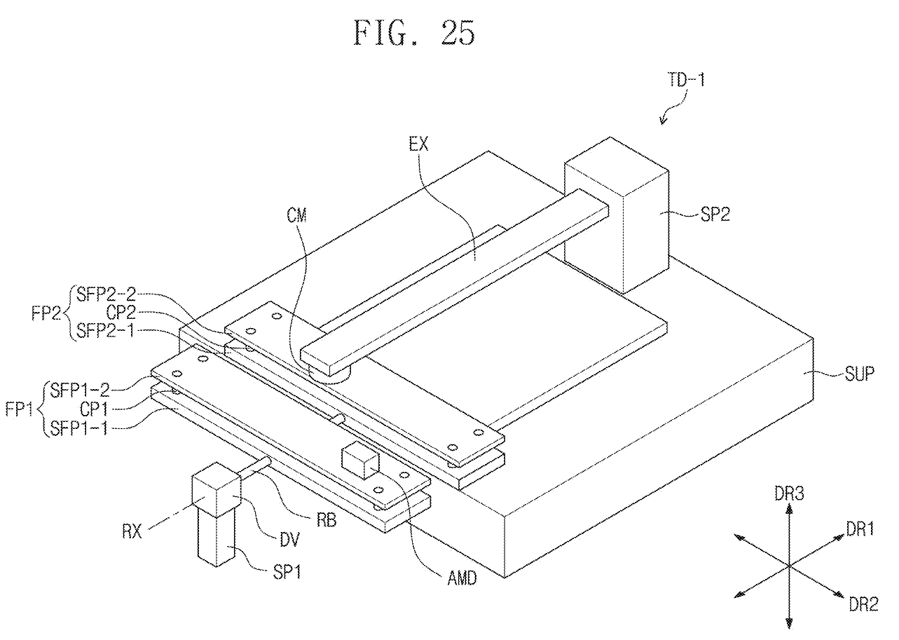

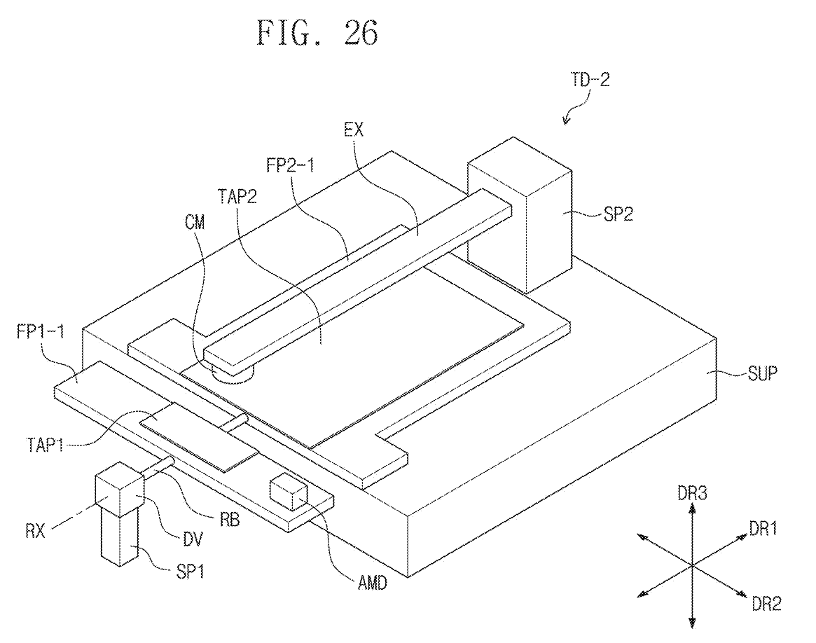

FIGS. 25-27 are views illustrating test devices according to embodiments of the present disclosure.

As an example, FIGS. 25-27 are perspective views corresponding to FIG. 1. Hereinafter, the configurations illustrated in FIGS. 25-27 will be described, primarily focusing on the components and configurations different from those illustrated in FIG. 1.

Referring to FIG. 25, a test device TD-1 does not include the protractor AGM illustrated in FIG. 1 but may include an angle measuring device AMD. The angle measuring device AMD may be disposed on a first fixing portion FP1. For example, the angle measuring device AMD may be disposed on a first-second fixing portion SFP1-2.

The angle measuring device AMD may measure the rotation angle of the first fixing portion FP1 when the first fixing portion FP1 rotates and may provide the measured rotation angle to the user. The angle measuring device AMD may include an angle measuring sensor to sense (e.g., to measure) the rotation angle of the first fixing portion FP1 and a display unit to display the sensed angle to the user.

Referring to FIG. 26, a test device TD-2 may include a first fixing portion FP1-1 and a second fixing portion FP2-1. Each of the first fixing portion FP1 and the second fixing portion FP2 illustrated in FIG. 1 includes two upper and lower structures, however, each of the first fixing portion FP1-1 and the second fixing portion FP2-1 illustrated in FIG. 26 may be provided as a single structure.

The first fixing portion FP1-1 may generally correspond to the first-first fixing portion SFP1-1 illustrated in FIG. 1, and the second fixing portion FP2-1 may generally correspond to the second-first fixing portion SFP2-1 illustrated in FIG. 1. A rotating bar RB may be connected to the first fixing portion FP1-1 and the second fixing portion FP2-1.

The test device TD-2 may include a first tape TAP1 disposed on an upper surface of the first fixing portion FP1-1 and a second tape TAP2 disposed on an upper surface of the second fixing portion FP2-1. Each of the first tape TAP1 and the second tape TAP2 may be a double-sided tape.

In the test device TD-2, a protractor AGM is not used (e.g., is omitted), and an angle measuring device AMD may be used. The angle measuring device AMD may be spaced apart from the first tape TAP1, may be adjacent to an edge of the first fixing portion FP1-1, and may be disposed on the upper surface of the first fixing portion FP1-1.

The printed circuit board PCB illustrated in FIG. 7 may be disposed on the first tape TAP1 and attached to the first tape TAP1. In addition, the display panel DP illustrated in FIG. 7 may be disposed on the second tape TAP2 and attached to the second tape TAP2. Because the printed circuit board PCB is fixed to the first tape TAP1, the display panel DP is fixed to the second tape TAP2, and the rotating bar RB rotates, the twist test for the flexible printed circuit board FPCB may be performed as described above.

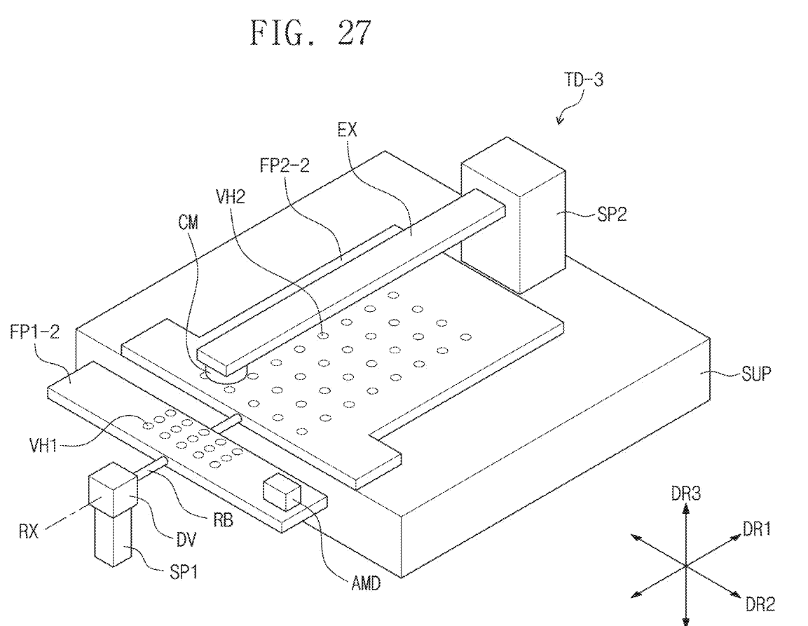

Referring to FIG. 27, a test device TD-3 may include a first fixing portion FP1-2 and a second fixing portion FP2-2. Similar to the configuration illustrated in FIG. 26, each of the first fixing portion FP1-2 and the second fixing portion FP2-2 illustrated in FIG. 27 may be provided as a single structure.

The first fixing portion FP1-2 may generally correspond to the first-first fixing portion SFP1-1 illustrated in FIG. 1, and the second fixing portion FP2-2 may generally correspond to the second-first fixing portion SFP2-1 illustrated in FIG. 1. A rotating bar RB may be connected to the first fixing portion FP1-2 and the second fixing portion FP2-2.

A plurality of first vacuum suction holes (e.g., first vacuum suction openings) VH1 may be defined through an upper surface of the first fixing portion FP1-2. A plurality of second vacuum suction holes (e.g., second vacuum suction openings) VH2 may be defined through an upper surface of the second fixing portion FP2-2. The first and second vacuum suction holes VH1 and VH2 may be maintained in a vacuum state to generate suction force.

In the test device TD-3, an angle measuring device AMD may be used. The angle measuring device AMD may be spaced apart from the first vacuum suction holes VH1, may be adjacent to an edge of the first fixing portion FP1-2, and may be disposed on the upper surface of the first fixing portion FP1-2.

The printed circuit board PCB illustrated in FIG. 7 may be disposed on the upper surface of the first fixing portion FP1-2 and fixed to the first fixing portion FP1-2 by the suction force generated from the first vacuum suction holes VH1. In addition, the display panel DP illustrated in FIG. 7 may be disposed on the upper surface of the second fixing portion FP2-2 and fixed to the second fixing portion FP2-2 by the suction force generated from the second vacuum suction holes VH2. Since the printed circuit board PCB is fixed to the first fixing portion FP1-2, the display panel DP is fixed to the second fixing portion FP2-2, and the rotating bar RB rotates, the twist test for the flexible printed circuit board FPCB may be performed as described above.

Although embodiments of the present disclosure have been described, it is understood that the present disclosure should not be limited to the above-described embodiments but that various changes and modifications can be made by one ordinary skilled in the art within the spirit and scope of the present disclosure as hereinafter claimed.

Therefore, the disclosed subject matter should not be limited to any single embodiment described herein, and the scope of the present disclosure shall be determined according to the attached claims and their equivalents.

What is claimed is:

1. A test device comprising:
a first fixing portion configured to fix a printed circuit board connected to one of two sides of a flexible printed circuit board, the two sides of the flexible printed circuit board being opposite to each other in a first direction;
a second fixing portion spaced apart from the first fixing portion in the first direction and configured to fix a display panel connected to the other of the two sides of the flexible printed circuit board; and
a rotating bar extending in the first direction and connected to the first fixing portion and the second fixing portion, the rotating bar being configured to rotate about a rotation axis defined at a center of the rotating bar and extending in the first direction when viewed in the first direction.

2. The test device of claim 1, wherein the first fixing portion is configured to rotate about the rotation axis in a clockwise direction or a counter-clockwise direction according to the rotating bar, and
wherein a position of the second fixing portion is fixed.

3. The test device of claim 1, wherein the rotating bar is under the printed circuit board, the flexible printed circuit board, and the display panel.

4. The test device of claim 1, wherein the rotating bar is fixedly connected to the first fixing portion and rotatably connected to the second fixing portion.

5. The test device of claim 1, further comprising a protractor on one side surface of the second fixing portion facing the first fixing portion in the first direction,
wherein the protractor is on the display panel.

6. The test device of claim 1, wherein the first fixing portion comprises:
a first-first fixing portion;
a first-second fixing portion on the first-first fixing portion; and
a plurality of first connection portions between the first-first fixing portion and the first-second fixing portion and connected to the first-first fixing portion and the first-second fixing portion, and
wherein the printed circuit board is between the first-first fixing portion and the first-second fixing portion.

7. The test device of claim 6, wherein the first-first fixing portion and the first-second fixing portion are configured to move closer to or farther away from each other by the first connection portions in a vertical direction.

8. The test device of claim 6, wherein the printed circuit board is between the first connection portions when viewed in the first direction.

9. The test device of claim 6, wherein the second fixing portion comprises:
a second-first fixing portion;
a second-second fixing portion on the second-first fixing portion; and
a plurality of second connection portions between the second-first fixing portion and the second-second fixing portion and connected to the second-first fixing portion and the second-second fixing portion, and
wherein the display panel is between the second-first fixing portion and the second-second fixing portion.

10. The test device of claim 9, wherein the second-first fixing portion and the second-second fixing portion are configured to move closer to or farther away from each other by the second connection portions in a vertical direction.

11. The test device of claim 9, wherein the display panel is between the second connection portions when viewed in the first direction.

12. The test device of claim 9, wherein the rotating bar is connected to the first-first fixing portion and the second-first fixing portion.

13. The test device of claim 9, further comprising a protractor connected to one side surface of the second-second fixing portion facing the first-second fixing portion in the first direction,
wherein a center of a circle having an arc of the protractor is defined in the protractor, and the center overlaps with the rotation axis when viewed in a plane.

14. The test device of claim 1, further comprising:
a supporter under the second fixing portion; and
a driver connected to the rotating bar and configured to rotate the rotating bar.

15. The test device of claim 1, further comprising a camera on the flexible printed circuit board.

16. The test device of claim 1, further comprising an angle measuring device on the first fixing portion.

17. The test device of claim 1, further comprising:
a first tape on an upper surface of the first fixing portion; and
a second tape on an upper surface of the second fixing portion,
wherein the printed circuit board is on the first tape, and the display panel is on the second tape.

18. The test device of claim 1, wherein a plurality of first vacuum suction openings is defined through an upper surface of the first fixing portion, a plurality of second vacuum suction openings is defined through an upper surface of the second fixing portion, and
wherein the printed circuit board is on the upper surface of the first fixing portion, and the display panel is on the upper surface of the second fixing portion.

19. A test device comprising:
a first fixing portion configured to fix a first area of a display panel having the first area, a bending area, and a second area, which are continuously arranged in a first direction;
a second fixing portion spaced apart from the first fixing portion in the first direction and configured to fix a printed circuit board connected to the second area;
a rotating bar extending in the first direction and connected to the first fixing portion and the second fixing portion; and
a protractor on one side surface of the second fixing portion facing the first fixing portion in the first direction,
wherein the rotating bar is configured to rotate about a rotation axis defined at a center of the rotating bar and extending in the first direction when viewed in the first direction.

20. A test method comprising:
fixing, by a first fixing portion, a printed circuit board connected to one of two sides of a flexible printed circuit board, the two sides of the flexible printed circuit board being opposite to each other in a first direction;
fixing, by a second fixing portion spaced apart from the first fixing portion in the first direction, a display panel connected to the other of the two sides of the flexible printed circuit board;
gradually rotating, by a rotating bar extending in the first direction and connected to the first fixing portion and the second fixing portion, the first fixing portion; and
capturing an image of the flexible printed circuit board,
wherein the rotating bar rotates about a rotation axis defined at a center of the rotating bar and extending in the first direction when viewed in the first direction, the first fixing portion rotates about the rotation axis in a clockwise direction or a counter-clockwise direction by the rotating bar, and a position of the second fixing portion is fixed.
